(19) United States
(12) Patent Application Publication
(10) Pub. No.: US 2026/0140379 A1
(43) Pub. Date: May 21, 2026

(54) DISPLAY APPARATUS

(71) Applicant: TRIPLE WIN TECHNOLOGY(SHENZHEN) CO. LTD., Shenzhen (CN)

(72) Inventors: CHENG-HSING LIAO, New Taipei (TW); YEW-KOON CHEE, New Taipei (TW); MING-CHUAN KUO, New Taipei (TW)

(21) Appl. No.: 19/185,481

(22) Filed: Apr. 22, 2025

(30) Foreign Application Priority Data
Nov. 15, 2024 (CN) 202411637511.4

(51) Int. Cl. G02B 27/01

(52) U.S. Cl. CPC G02B 27/0172; G02B 2027/011

(57) ABSTRACT

A display apparatus includes a first micro-display configured to emit a first light beam; a first meta-optical structure configured to adjust a propagation direction of the first light beam; a second micro-display configured to emit a second light beam, and a wavelength of the first light beam is different from a wavelength of the second light beam; a light combining element including a light exit surface, and the light combining element being configured to transmit the first light beam and the second light beam through the light exit surface; a projection lens configured to receive the first light beam and the second light beam from the light exit surface; and an optical waveguide configured to receive the first light beam and the second light beam from the projection lens, wherein the projection lens project the first light beam and the second light beam to the optical waveguide in different directions.

### FIELD

The subject matter herein generally relates to a display apparatus.

### BACKGROUND

A wearable display apparatus may include a display, a X-cube, an optical waveguide, etc. Color wearable display apparatus receives light beams of different wavelengths (representing different colors) and combines the light beams to generate image light. The image light undergoes multiple total reflections in the optical waveguide and are coupled to human eye to display images.

However, due to different wavelengths of the light beams in the image light, the following issues exist.

(1) The light beams have different diffraction angles in the optical waveguide, causing the light beams to have different optical path lengths during each total reflection. As such, the light beams in the image light are coupled out of the optical waveguide for different times and at different positions, which can lead to uneven color ratios at different observation positions in an eye box, resulting in a “rainbow effect”.

(2) For the light beams of a same color, a diffraction efficiency varies with different incident angles, which leads to different distribution ratios within an entire field of view (FOV) and also results in the “rainbow effect”.

### BRIEF DESCRIPTION OF THE DRAWINGS

Implementations of the present disclosure will now be described, by way of embodiment, with reference to the attached figures, wherein:

FIG. 1 shows a display apparatus according to a first embodiment of the present disclosure.

FIG. 2 shows a display apparatus according to a second embodiment of the present disclosure.

FIG. 3 is a planar view of an embodiment of an optical waveguide of the display apparatus shown in in FIG. 2.

FIG. 4 is a planar view of another embodiment of an optical waveguide.

FIG. 5 is a planar view of another embodiment of an optical waveguide.

FIG. 6 is a planar view of yet another embodiment of an optical waveguide.

FIG. 7 shows optical paths of light beams in the display apparatus shown in FIG. 2.

FIG. 8 shows a display apparatus according to a third embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

“Above” means one layer is on top of another layer. In one example, it means one layer is situated directly on top of another layer. In another example, it means one layer is situated over the second layer directly or indirectly with more layers or spacers in between.

When a feature or element is herein referred to as being “on” another feature or element, it can be directly on the other feature or element or intervening features and/or elements may also be present. It will also be understood that, when a feature or element is referred to as being “connected”, to another feature or element, it can be directly connected, attached, or coupled to the other feature or element or an intervening features or elements may be present.

### Embodiment 1

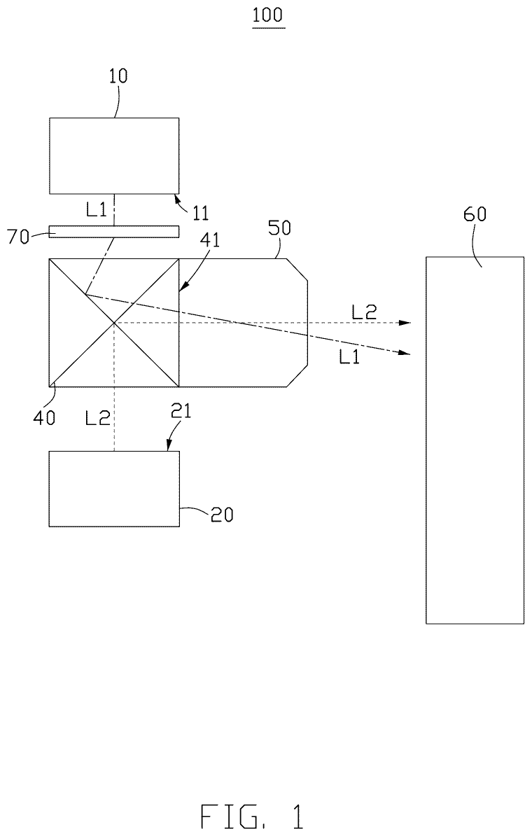

Referring to FIG. 1, a display apparatus 100 in this embodiment includes a first micro-display 10 including a first display surface 11, a second micro-display 20 including a second display surface 21, a light combining element 40 including a light exit surface 41, a projection lens 50, an optical waveguide 60, and a first meta-optical structure.

The first micro-display 10 is used to emit a first light beam L1 through the first display surface 11, the second micro-display 20 is used to emit a second light beam L2 through the second display surface 21, the first light beam L1 and the second light beam L2 have different wavelengths, and the first light beam L1 and the second light beam L2 have different colors. The light combining element 40 is on optical paths of the first light beam L1 and the second light beam L2 and is used to receive the first light beam L1 and the second light beam L2. The light combining element 40 is further used to reflect the first light beam L1 and the second light beam L2 to the light exit surface 41 to exit the first light beam L1 and the second light beam L2. The projection lens 50 is used to receive the first light beam L1 and the second light beam L2 from the light exit surface 41. The projection lens 50 is further used to project the first light beam L1 and the second light beam L2 after modulating optical parameters such as a focal length and a dispersion of the first light beam L1 and the second light beam L2. The optical waveguide 60 is used to receive the first light beam L1 and the second light beam L2 from the projection lens 50. The first light beam L1 and the second light beam L2 are coupled out of the optical waveguide 60 after multiple total reflections in the optical waveguide 60. The first light beam L1 and second light beam L2 coupled out of the optical waveguide 60 can be projected into an eye box to display images.

In this embodiment, the first light beam L1 is emitted in a direction perpendicular to the first display surface 11, the second light beam L2 is emitted in a direction perpendicular to the second display surface 21, the light exit surface 41 of the light combining element 40 directs the first light beam L1 and the second light beam L2 towards the projection lens 50 at different angles(that is, in different directions, in respective directions), the projection lens 50 also project the first light beam L1 and the second light beam L2 at different angles, and the first light beam L1 and the second light beam L2 with different wavelengths incident on a surface of the optical waveguide 60 at different angles. That is, the first light beam L1 incidents on a surface of the optical waveguide 60 in a first direction, the second light beam L2 incidents on the surface of the optical waveguide 60 in a second direction, and the first direction and the second direction are not parallel to each other.

In this embodiment, the first meta-optical structure 70 is between the first micro-display 10 and the light combining element 40 and is respectively spaced apart from the first micro-display 10 and the light combining element 40. The first meta-optical structure 7 is on an optical path of the first light beam L1 and is used to adjust a propagation direction of the first light beam L1. The first light beam L1 incidents on the first meta-optical structure 70 perpendicular to the first meta-optical structure 70. the first meta-optical structure 70 emits the first light beam L1 to the light combining element 40 not perpendicular to the light combining element 40.

The first meta-optical structure 70 is used to adjust propagation directions of the first light beam L1 and the second light beam L2, respectively, so that the first light beam L1 and the second light beam L2 incident on the light combining element 40 in different directions and emit from the light emitting surface 41 of the light combining element 40 to the projection lens 50 in different directions. Thus, the first light beam L1 and the second light beam L2 emit from the projection lens 50 in different directions and incident on the optical waveguide 60 in different directions. In this embodiment, the first light beam L1 incident on the optical waveguide 60 in a first direction, the second light beam L2 incident on the optical waveguide 60 in a second direction. An angle between the first direction and the second direction can be determined by the directions in which the first light beam L1 and the second light beam L2 enter the light combining element 40. In at least one embodiment of the disclosure, a second meta-optical structure can also be included between the second micro-display 20 and the light combining element 40 to adjust the propagation direction of the second light beam L2.

The display apparatus 100 is used to display color images. The display apparatus 100 is used to emit the first light beam L1 and the second light beam L2 of different wavelengths (different colors), and the display apparatus 100 includes the optical waveguide 60 for guiding the first light beam L1 and the second light beam L2. The first light beam L1 and second light beam L2 of different wavelengths enter the optical waveguide 60 non-parallel (at different angles, or at different directions) by adjusting the propagation direction of the first light beam through the first meta-optical structure 70, thus a “rainbow effect” caused by a wavelength difference between the first light beam L1 and the second light beam L2 can be effectively improved.

### Embodiment 2

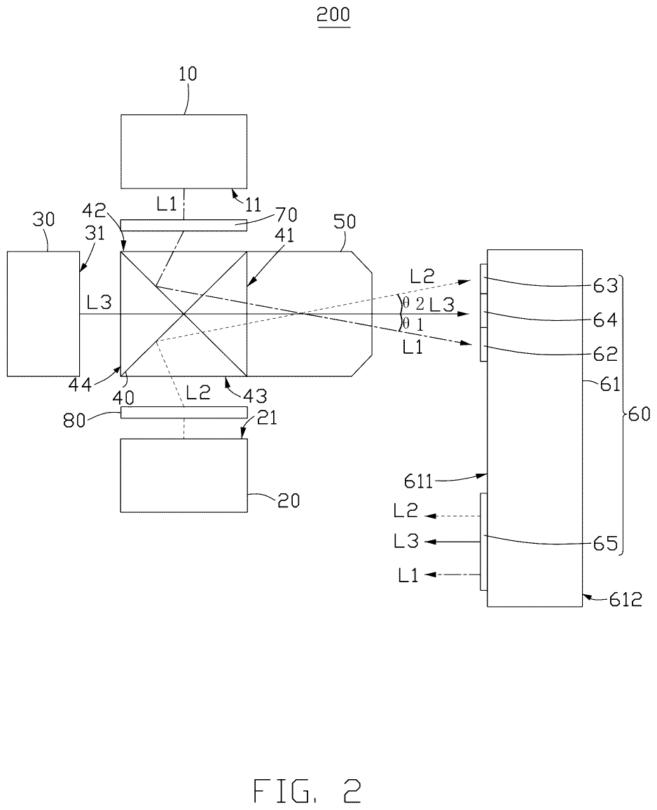

Referring to FIG. 2, a display apparatus 200 in this embodiment includes the first micro-display 10, the second micro-display 20, a third micro-display 30, the light combining element 40, the projection lens 50, the optical waveguide 60, the first meta-optical structure 70, and a second meta-optical structure 80. The first micro-display 10, the second micro-display 20, and the third micro-display 30 are respectively used to emit three kinds of light beams with different wavelengths. The light combining element 40 is used to combine and transmit the three kinds of light beams. The projection lens 50 is used to modulate the optical parameters such as the focal length and the dispersion of a combined light formed by the three kinds of light beams. The optical waveguide 60 is used to transmit the combined light from the projection lens 50 to the human eye for imaging.

The first micro-display 10 defines the first display surface 11 and is used to emit the first light beam L1 through the first display surface 11 perpendicular to the first display surface 11. The second micro-display 20 defines the second display surface 21 and is used to emit the second light beam L2 through the second display surface 21 perpendicular to the second display surface 21. The third micro-display 30 defines a third display surface 31 and is used to emit the third light beam L3 through the third display surface 31 perpendicular to the third display surface 31. In this embodiment, the first display surface 11 and the second display surface 21 are spaced apart and parallel to each other. The third display surface 31 is perpendicular to the first display surface 11 and the second display surface 22, respectively.

In this embodiment, the first meta-optical structure 70 is between the first micro-display 10 and the light combining element 40 and the first meta-optical structure 70 is spaced apart from the first micro-display 10 and the light combining element 40. The first light beam L1 incidents on the first meta-optical structure 70 perpendicularly. The first meta-optical structure 70 is used to adjust the propagation direction of the first light beam L1 to make the first light beam L1 transmit out of the first meta-optical structure 70 not perpendicular to the first meta-optical structure 70. The second meta-optical structure 80 is between the second micro-display 20 and the light combining element 40 and the second meta-optical structure 80 is spaced apart from the second micro-display 20 and the light combining element 40. The second light beam L2 incidents on the second meta-optical structure 80 perpendicular to the second meta-optical structure 80. The second meta-optical structure 80 is used to adjust the propagation direction of the second light beam L2 to make the second light beam L2 transmit out of the second meta-optical structure 80 not perpendicular to the second meta-optical structure 80.

In at least one embodiment of the present disclosure, the third micro-display 30 can emit the third light beam L3 through the third display surface 31 not perpendicular to the third display surface 31. In at least one embodiment of the present disclosure, the display apparatus 200 may further include a third meta-optical structure between the third micro-display 30 and the light combining element 40, wherein the third meta-optical structure 80 is used to adjust a propagation direction of the third light beam L3 to make the third light beam L3 transmit out of the third meta-optical structure not perpendicular to the third meta-optical structure.

In this embodiment, the display apparatus 200 can be a head-mounted display, an augmented reality (AR) glasses, a virtual reality (VR) glasses, or a head-up display (HUD). The wavelength of the third light beam L3 is smaller than the wavelength of the first light beam L1 and is larger than the wavelength of the second light beam L2. The third light beam L3 incident to a surface of the optical waveguide 60 vertically, and the first light beam L1 and the second light beam L2 are on both sides of the third light beam L3. In this embodiment, the first light beam L1 is red light, the second light beam L2 is blue light, and the third light beam L3 is green light. The display apparatus 200 can achieve full color display according to a combined light of the first light beam L1, the second light beam L2 and the third light beam L3. In other embodiments of this disclosure, the first light beam L1, the second light beam L2, and the third light beam L3 may be other colors, and colors of the first light beam L1, the second light beam L2, and the third light beam L3 are different.

In this embodiment, the first micro-display 10, the second micro-display 20, and the third micro-display 30 can be light-emitting diode (LED) displays, organic light-emitting diodes (OLED) displays, mini light-emitting diode (Mini-LED) displays, micro light-emitting diode (Micro-LED) displays, liquid crystal on silicon (LCOS) displays, etc.

The light combining element 40 is in a space formed by the first micro-display 10, the second micro-display 20, and the third micro-display 30 and is on optical paths of the first light beam L1, the second light beam L2 and the third light beam L3. In the present embodiment, the light combining element 40 is a X-prism (or X-cube). The light combining element 40 further includes a first incident surface 42, a second incident surface 43 and a third incident surface 44. The first incident surface 42, the third incident surface 44, the second incident surface 43 and the light exit surface 41 are connected sequentially. The first display surface 11, the first incident surface 42, the second incident surface 43 and the second display surface 21 are parallel to each other and sequentially spaced.

The first incident surface 42 faces the first display surface 11 and is used to receive the first light beam L1. The second incident surface 43 faces the second display surface 21 and is used to receive the second light beam L2. The third incident surface 44 faces the third display surface 31 and is used to receive the third light beam L3. The third display surface 31, the third incident surface 44 and the light exit surface 41 are parallel to each other and sequentially spaced.

The first light beam L1 from the first meta-optical structure 70 is non-vertically incident to the first incident surface 42 and transmitted to the light combining element 40, the second light beam L2 from the second display surface 21 is non-vertically incident to the second incident surface 43 and transmitted to the light combining element 40, and the third light beam L3 from the third display surface 31 is vertically incident to the third incident surface 44 and transmitted to the light combining element 40. The light combining element 40 is used to reflect the first light beam L1 and the second light beam L2 to the light exit surface 41 and to transmit the third light beam L3 to the light exit surface 41 so that the combined light of the first light beam L1, the second light beam L2 and the third light beam L3 are transmitted from the light exit surface 41 to the projection lens 50.

In this embodiment, the first light beam L1, second light beam L2, and third light beam L3 are transmitted from the light exit surface 41 in different angles (that is, in different directions). The third light beam L3 transmits from the light exit surface 41 and is perpendicular to the light exit surface 41, and the first light beam L1 and the second light beam L2 are on different sides of the third light beam L3.

The projection lens 50 is on the optical path of the first light beam L1, the second light beam L2 and the third light beam L3. In this embodiment, the projection lens 50 may include a lens (or group of lenses), a polarizer, a filter, and other optical elements for modulating the optical parameters of the first light beam L1, the second light beam L2, and the third light beam L3. In this embodiment, the projection lens 50 is used to receive the first light beam L1, the second light beam L2, and the third light beam L3 from the light exit surface 41 and project the first light beams L1, the second light beams L2, and the third light beams L3 in different directions.

The optical waveguide 60 is on a side of the projection lens 50 away from the light combining element 40 and is used to receive the first light beam L1, the second light beam L2 and the third light beam L3 from the projection lens 50. The optical waveguide 60 is further used to couple out the first light beam L1, the second light beam L2 and the third light beam L3 for imaging. The first light beam L1, the second light beam L2 and the third light beam L3 enter the optical waveguide 60 at different angles. That is, the third light beam L3 incident on the optical waveguide 60 in a third direction, and the first direction, the second direction and the third direction are not parallel to each other.

In this embodiment, the third light beam L3 is vertically incident to the optical waveguide 60, and the first light beam L1 and the second light beam L2 are non-vertically incident to the optical waveguide 60 and are on different sides of the third light beam L3. In this embodiment, the first light beam L1 and the second light beam L2 are symmetrically distributed on both sides of the third light beam L3. When the first light beam L1, the second light beam L2 and the third light beam L3 enter the optical waveguide 60, a first angle θ1 between the first direction and the third direction is equal to a second angle θ2 between the second direction and the third direction. In other embodiments of this disclosure, when the first light beam L1, the second light beam L2 and the third light beam L3 enter the optical waveguide 60, the first angle θ1 may not be equal to the second angle θ1.

For example, in at least one embodiment of this disclosure, the first angle θ1 is less than or equal to 20° and the second angle θ2 is less than or equal to 20°. In at least one embodiment of this application, the first angle θ1 may be 5°, 10°, etc., and the second angle θ2 may also be 5°, 10°, etc. In this embodiment, the first angle θ1 and the second angle θ2 are related to wavelengths of the first light beam L1, the second light beam L2, and the third light beam L3, a refractive index of the optical waveguide 60, etc.

In the present embodiment, the optical waveguide 60 includes a single waveguide layer 61 and a first in-coupling grating 62, a second in-coupling grating 63, a third in-coupling grating 64, and an out-coupling grating 65 on a same surface of the waveguide layer 61. The first in-coupling grating 62 and the second in-coupling grating 63 are on both sides of the third in-coupling grating 64. The waveguide layer 61 includes a first surface 611 and a second surface 612 spaced apart and parallel to each other, and the first surface 611 is parallel to the light exit surface 41 of the light combining element 40. The first surface 611 is between the projection lens 50 and the second surface 612. The first in-coupling grating 62, the second in-coupling grating 63, the third in-coupling grating 64, and the out-coupling grating 65 are spaced apart on the first surface 611.

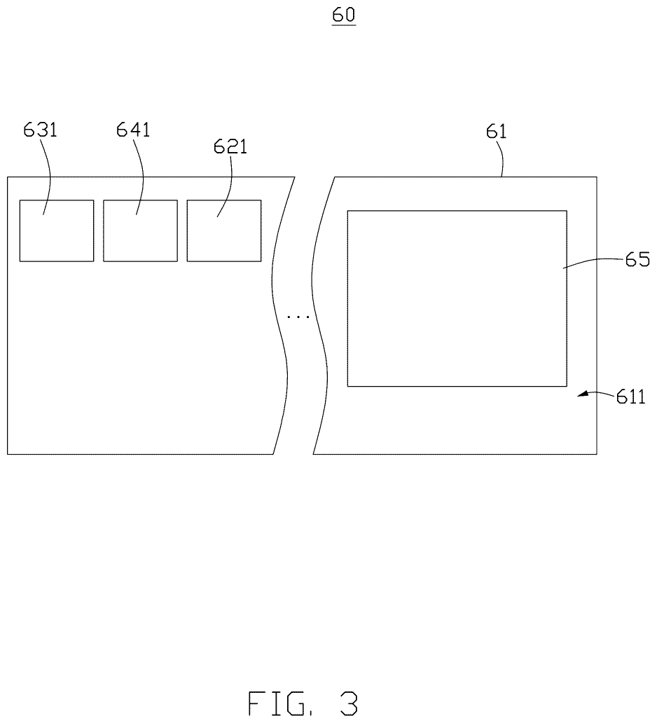

Referring to FIG. 3, in this embodiment, the first in-coupling grating 62, the second in-coupling grating 63, and the third in-coupling grating 64 are spaced apart on the first surface 611. An orthography projection of the first in-coupling grating 62 on the first surface 611 of the waveguide layer 61 is defined as a first in-coupling area 621, an orthography projection of the second in-coupling grating 63 on the first surface 611 of the waveguide layer 61 is defined as a second in-coupling area 631, and an orthographic projection of the third in-coupling grating 64 on the first surface 611 of the waveguide layer 61 is defined as a third in-coupling area 641. The first in-coupling area 621 and the second in-coupling area 631 are on both sides of the third in-coupling area 641. The first light beam L1 is not vertically incident to the first in-coupling area 621, the second light beam L2 is not vertically incident to the second in-coupling area 631, and the third light beam L3 is vertically incident to the third in-coupling area 641.

In the display apparatus 200 according to the embodiment shown in FIG. 3, the first in-coupling area 621, the second in-coupling area 631 and the third in-coupling area 641 are spaced apart from each other because the first angle θ1 and the second angle θ2 have large angle sizes, wherein the third in-coupling area 641 is between the first in-coupling area 621 and the second in-coupling area 631. The larger the angle size, the greater distances between the third in-coupling area 641 and the first in-coupling area 621 and the second in-coupling area 631.

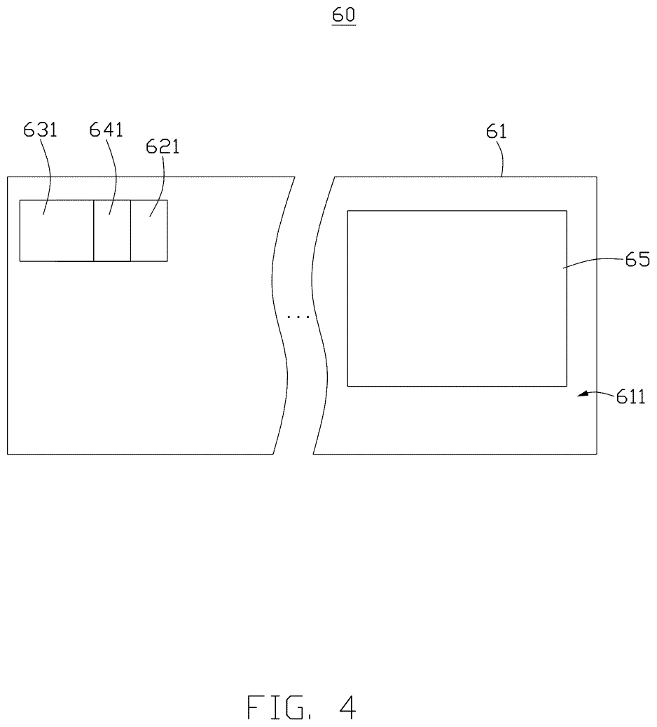

Referring to FIG. 4, in other embodiments, since the first angle θ1 and the second angle θ2 have small angle sizes, the third in-coupling area 641 may partially overlap with the first in-coupling area 621 and the second in-coupling area 631, respectively. The smaller the angle sizes, the larger overlapping areas of the third in-coupling area 641 and the first in-coupling area 621 and the second in-coupling area 631.

In the other embodiment, the first in-coupling grating 62, the second in-coupling grating 63, and the third in-coupling grating 64 are stacked sequentially, wherein the third in-coupling grating 64 is between the first in-coupling grating 62 and the second in-coupling grating 63. A sequence of the first in-coupling grating 62, the second in-coupling grating 63, and the third in-coupling grating 64 is not limited, and an overlapping relationship of the first in-coupling area 621, the second in-coupling area 631 and the third in-coupling area 641 is not limited, areas of the first in-coupling grating 62, the second in-coupling grating 63 and the third in-coupling grating 64 are not limited, an areas of the first in-coupling area 621, the second in-coupling area 631, and the third in-coupling area 641.

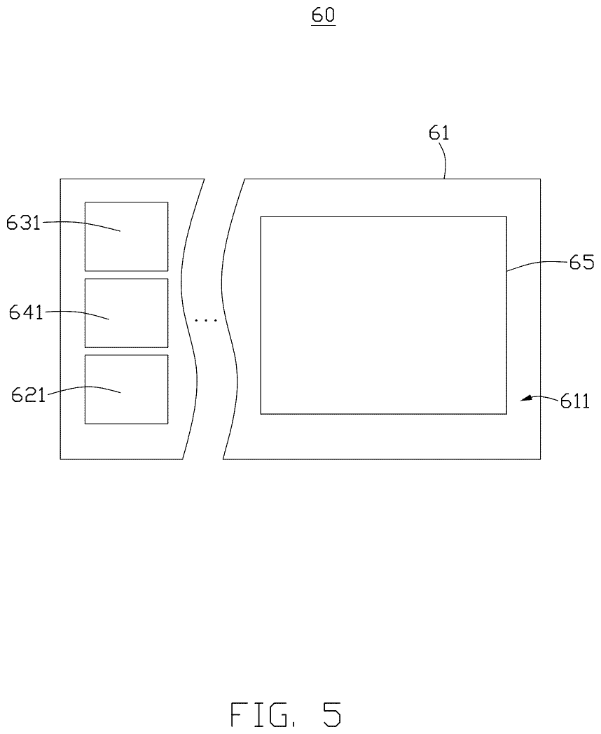

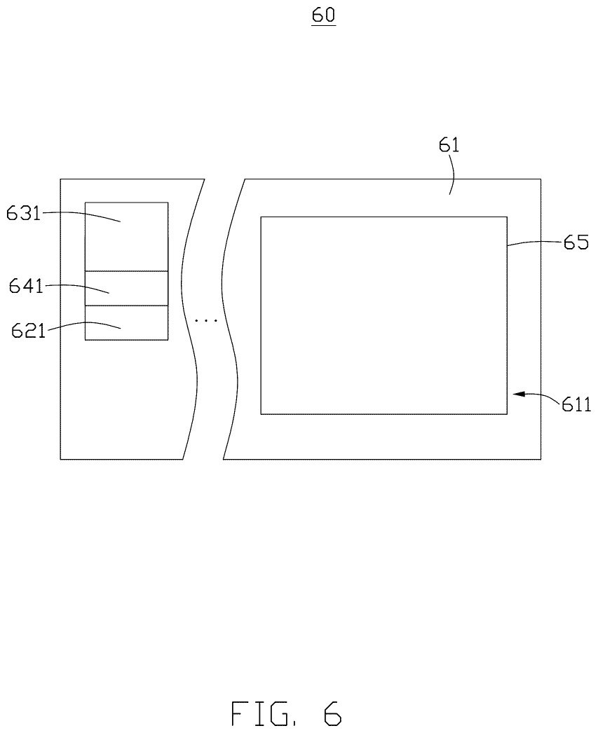

Referring to FIG. 5 and FIG. 6, in other embodiments of this disclosure, the first in-coupling grating 62, the second in-coupling grating 63 and the third in-coupling grating 64 on the waveguide layer 61 are arranged in different ways, resulting in different position relationships between the first in-coupling area 621, the second in-coupling area 631 and the third in-coupling area 641. As shown in FIG. 5 and FIG. 6, in at least one embodiment, the first in-coupling area 621, the second in-coupling area 631, and the third in-coupling area 641 are next to each other in a vertical direction instead of a horizontal direction as shown in FIG. 3 and FIG. 4, and the first light beam L1 and second light beam L2 are distributed in on both sides(an upper side and a bottom side) of the third light beam L3 in a different way from FIG. 3 and FIG. 4.

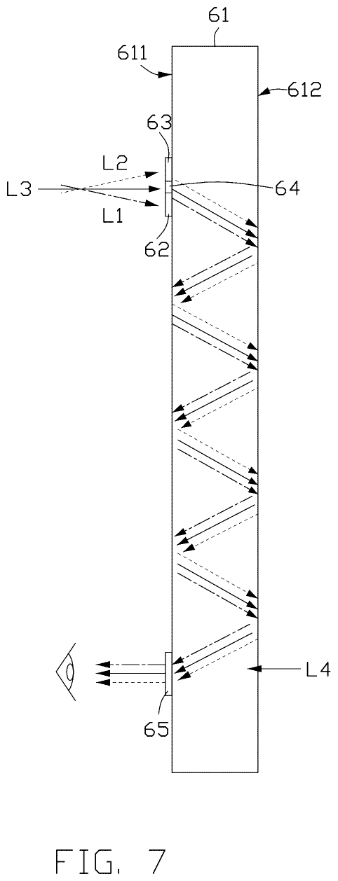

Referring to FIG. 7, in this embodiment, the three in-coupling gratings (62, 63, 64) locates at one end of the first surface 611, and the out-coupling grating 65 locates at the other end of the first surface 611. The first light beam L1, the second light beam L2, and the third light beam L3 coupled from the three in-coupling gratings coupled out from the out-coupling grating 65 after multiple total reflections in the waveguide layer 61, wherein first light beam L1, the second light beam L2, and the third light beam L3 are coupled to the user's eye box to display color images. When the display apparatus 200 is an AR glass, the waveguide layer 61 is also used to transmit ambient light L4. The ambient light L4 is transmitted from the second surface 612 to the first surface 611 and coupled out from the coupled grating 65 with the first light beam L1, the second light beam L2 and the third light beam L3, so that the human eye can simultaneously observe the images displayed by the display apparatus 200 and the real world (that is, the AR image).

In this embodiment, the display apparatus 200 includes the first meta-optical structure 70 and the second meta-optical structure 80. The first meta-optical structure 70 transmits the first light beam L1 not perpendicular to the first incident surface 42, and the second meta-optical structure 80 transmits the second light beam L2 not perpendicular to the first incident surface 42, such that the first light beam L1, the second light beam L2, and the third light beam L3 are incident on the optical waveguide 60 in a non-parallel manner. Due to different wavelengths of the first light beam L1, the second light beam L2 and the third light beam L3, if the first light beam L1, the second light beam L2 and the third light beam L3 incident on the optical waveguide 60 parallel, total reflection angles of the first light beam L1, the second light beam L2 and the third light beam L3 in the optical waveguide 60 will be different, which leads to the first light beam L1, the second light beam L2 and the third light beam L3 coupling out from different positions of the optical waveguide 60 and uneven distribution of the light beams in the eye box, thereby the “rainbow effect” is caused.

Therefore, the display apparatus 200 of this embodiment can reduce differences of the total reflection angles of the first light beam L1, the second light beam L2 and the third light beam L3 in the optical waveguide 60 by making the first light beam L1, the second light beam L2 and the third light beam L3 incident on the optical waveguide 60 non-parallel. Thus, the first light beam L1, the second light beam L2, and the third light beam L3 propagate in the optical waveguide 60 tending parallel, thereby coupling the first light beam L1, the second light beam L2, and the third light beam L3 out of the optical waveguide 60 parallelly, ensuring uniform distribution of various light beam within the eye box, improving the “rainbow effect”, and enhancing a color effect of the images displayed by the display device 200.

### Embodiment 3

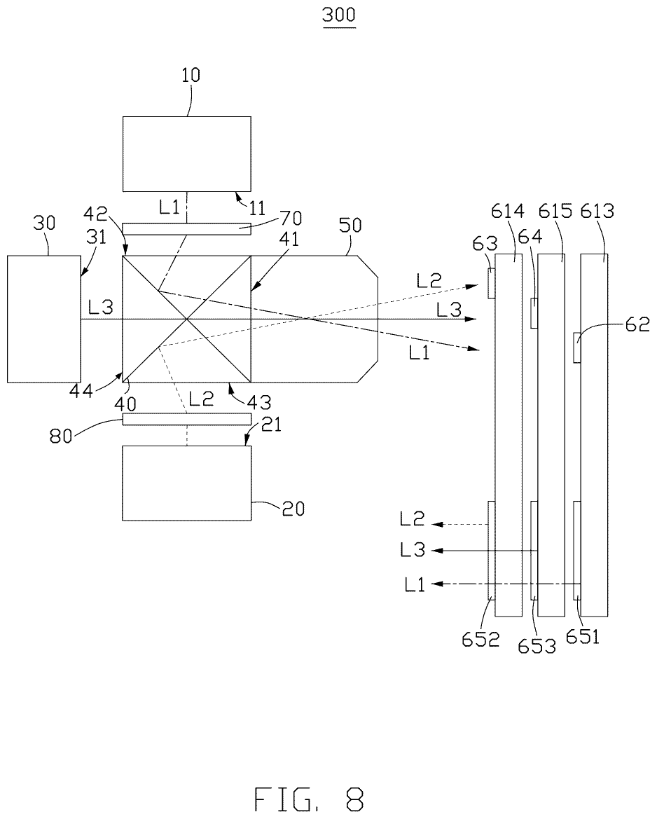

Referring to FIG. 8, a main difference between a display apparatus 300 in this embodiment and the display apparatus 200 in embodiment 1 is that structures of the optical waveguide 60 are different.

In this embodiment, the optical waveguide 60 includes a first waveguide layer 613, a second waveguide layer 614, and a third waveguide layer 615, wherein the first waveguide layer 613, the third waveguide layer 615, and the second waveguide layer 614 are sequentially spaced apart and are parallel to each other. The first in-coupling grating 62 is on a surface of the first waveguide layer 613 towards the projected lens 50, the second in-coupling grating 63 is on a surface of the second waveguide layer 614 towards the projected lens 50, and the third in-coupling grating 64 is on a surface of the third waveguide layer 615 towards the projected lens 50.

The first light beam L1 is coupled into the first waveguide layer 613 through the first in-coupling grating 62 and is coupled out to the eye box after multiple total reflections in the first waveguide layer 613. The second light beam L2 is coupled into the second waveguide layer 614 through the second in-coupling grating 63 and is coupled out to the eye box after multiple total reflections in the second waveguide layer 614. The third light beam L3 is coupled into the third waveguide layer 615 through the third in-coupling grating 64 and is coupled out to the eye box after multiple total reflections in the third waveguide layer 615.

In this embodiment, the optical waveguide 60 also includes a first out-coupling grating 651, a second out-coupling 652, and a third out-coupling 653. The first out-coupling 651 is on the surface of the first waveguide layer 613 towards the third waveguide layer 615. The second out-coupling 652 is on the surface of the second waveguide layer 614 away from the third waveguide layer 615. The third out-coupling 653 is on the surface of the third waveguide layer 615 towards the second waveguide layer 614. Orthographic projections of the first out-coupling 651, the second out-coupling 652 and the third out-coupling 653 on the first waveguide layer 613 completely overlapping. The first out-coupling 651 is used to vertically couple the first light beam L1 out of the first waveguide layer 613, the second out-coupling 652 is used to vertically couple the second light beam L2 out of the second waveguide layer 614, the third out-coupling 653 is used to vertically couple the third light beam L3 out of the third waveguide layer 615. The first light beam L1, the second light beam L2, and the third light beam L3 are parallelly coupled out of the second coupling grating 652 to the eye box.

In this embodiment, orthographic projections of the first in-coupling grating 62, the second in-coupling grating 63, and the third in-coupling grating 64 on either waveguide layer (the first waveguide layer 613, the second waveguide layer 614, or the third waveguide layer 615) are completely overlapping. That is, the orthographic projections of the first in-coupling grating 62, the second in-coupling grating 63, and the third in-coupling grating 64 on any waveguide layer are partially overlapped or are completely separated (connected or spaced apart from each other).

The display apparatus 300 in this embodiment can achieve all the beneficial effects of the display apparatus 100 in the first embodiment. The structure of the first micro-display 10, the second micro-display 20, and the third micro-display 30, the light combining element 40, the projection lens 50, the first meta-optical structure 70, and a second meta-optical structure 80 in this embodiment may be the same as described in any of the above-mentioned embodiments.

The display apparatuses (including display apparatus 100, 200, 300) in the above embodiments of this disclosure are used for displaying color images. The display apparatuses are used to transmit at least two kinds of light beams with different wavelengths, and the display apparatuses include an optical waveguide for transmitting the at least two kinds of light beams. The display apparatuses include at least one meta-optical structure to make the at least two kinds of light beams to incident on the optical waveguide in a non-parallel manner (that is, at different angles), which can compensate for total reflection angle difference caused by wavelength difference between the at least two kinds of light beams. Therefore, the total reflection angles of the at least two kinds of light beams tend to be the same when propagating in the optical waveguide. That is, the at least two kinds of light beams tend to propagate parallel in the optical waveguide, which causes color uniform when the at least two kinds of light beams coupled from the optical waveguide and can effectively improve the “rainbow effect”.

Finally, it should be noted that the above embodiments are only used to illustrate the technical solution of the present application and not to limit the present application. Although the present application has been described in detail with reference to preferred embodiments, one ordinary skill in the art should understand that the technical solution of the present application can be modified or equivalent replaced without departing from the spirit and scope of the technical solution of the present application.

What is claimed is:

1. A display apparatus comprising:
a first micro-display configured to emit a first light beam;
a first meta-optical structure on an optical path of the first light beam and configured to adjust a propagation direction of the first light beam such that the first meta-optical structure emits the first light beam not perpendicular to the first meta-optical structure;
a second micro-display configured to emit a second light beam of a wavelength different from a wavelength of the first light beam displayed by the first light beam;
a light combining element comprising a light exit surface, positioned on optical paths of the first light beam and the second light beam, and configured to receive the first light beam and the second light beam and transmit the first light beam and the second light beam through the light exit surface;
a projection lens configured to receive the first light beam and the second light beam from the light exit surface and project the first light beam and the second light beam at respective angles; and
an optical waveguide configured to receive the first light beam and the second light beam from the projection lens, wherein the projection lens project the first light beam and the second light beam on the optical waveguide in respective directions.

2. The display apparatus according to claim 1, wherein
the first micro-display is further configured to emit the first light beam not perpendicular to the first incident surface, and the second micro-display is further configured to emit the second light beam not perpendicular to the second incident surface;
the light combining element further comprises a first incident surface configured to receive the first light beam and a second incident surface configured to receive the second light beam; and light exit surface transmits the first light beam and the second light beam to the projection lens in respective directions.

3. The display apparatus according to claim 2, wherein the light combining element is a X-prism, and the first incident surface is parallel to the second incident surface and is perpendicular to the light exit surface.

4. The display apparatus according to claim 1, wherein the first meta-optical structure is a metalens.

5. The display apparatus according to claim 1, further comprises a second meta-optical structure between the second micro-display and the light combining element, wherein the second meta-optical structure is configured to adjust a propagation direction of the second light beam such that the second light beam incidents on the light combining element non-perpendicularly.

6. The display apparatus according to claim 5, wherein the second meta-optical structure is a metalens.

7. The display apparatus according to claim 1, wherein the optical waveguide comprises a first in-coupling grating, a second in-coupling grating, and at least one waveguide layer, the first in-coupling grating receives and couples the first light beam into the at least one waveguide layer, and the second in-coupling grating receives and couples the second light beam into the at least one waveguide layer; and
orthographic projections of the first in-coupling grating and the second in-coupling grating on respective surfaces of the at least one waveguide layer are adjacent to each other.

8. The display apparatus according to claim 7, wherein the at least one waveguide layer comprises a single waveguide layer configured for transmitting the first light beam and the second light beam, and the first in-coupling grating and the second in coupling grating are on a same surface of the single waveguide layer.

9. The display apparatus according to claim 7, wherein the at least one waveguide layers comprises a first waveguide layer configured for transmitting the first light beam and a second waveguide layer configured for transmitting the second light beam, the first waveguide layer is adjacent to the second waveguide layer, the first in-coupling grating is on the first waveguide layer, and the second in-coupling grating is on the second waveguide layer.

10. The display apparatus according to claim 1, further comprising a third micro-display configured for emitting a third light beam of a wavelength different from each of the wavelengths of the first light beam and the second light beam displayed by the first micro-display and the second micro-display, respective;
the light combining element is further configured to receive the first light beam, the second light beam, and the third light beam through the light exit surface, and transmit the first light beam, the second light beam, and the third light beam through the light exit surface; and
the projection lens is further configured to receive the first light beam, the second light beam, and the third light beam from the light exit surface, and project the first light beam, the second light beam, and the third light beam on the optical waveguide at the respective angles.

11. The display apparatus according to claim 10, wherein the optical waveguide further comprises a first in-coupling grating, a second in-coupling grating, a third in-coupling grating, and at least one waveguide layer, the first in-coupling grating receives and couples the first light beam into the at least one waveguide layer, the second in-coupling grating receives and couples the second light beam into the at least one waveguide layer, and the third in-coupling grating receives and couples the third light beam into the at least one waveguide layer; and
orthographic projections of the first in-coupling grating, the second in-coupling grating, and the third in-coupling grating on respective surfaces of the at least one waveguide layer are adjacent to each other.

12. The display apparatus according to claim 11, wherein the at least one waveguide layer comprises a single waveguide layer configured for transmitting the first light beam, the second light beam, and the third light beam, and the first in-coupling grating, the second in-coupling grating, and the third in-coupling grating are on a same surface of the single waveguide layer.

13. The display apparatus according to claim 11, wherein the at least one waveguide layers comprises a first waveguide layer configured for transmitting the first light beam, a second waveguide layer configured for transmitting the second light beam, and a third waveguide layer configured for transmitting the third light beam, the first waveguide layer, the second waveguide layer, and the third waveguide layer are sequentially stacked at intervals, the first in-coupling grating is on the first waveguide layer, the second in-coupling grating is on the second waveguide layer, and the third in-coupling grating is on the third waveguide layer.

14. The display apparatus according to claim 11, wherein the third micro-display is further configured to display the third light beam of a wavelength shorter than a wavelength of the first light beam displayed by the first micro-display, and longer than a wavelength of the second light beam displayed by the second micro-display, and the third micro-display is further configured to emit the third light beam in a third direction vertically to the optical waveguide.

15. The display apparatus according to claim 11, wherein the projection lens is further configured to project the first light beam on the optical waveguide in a first direction, project the second light beam on the optical waveguide in a second direction, and project the third light beam on the optical waveguide in a third direction; and
a first angle between the first direction and the third direction is equal to a second angle between the second direction and the third direction.

16. The display apparatus according to claim 1, wherein the optical waveguide is further configured to propagate the first light beam and the second light beam parallelly.

17. A display apparatus comprising:
a first micro-display configured to emit a first light beam;
a first meta-optical structure on an optical path of the first light beam and configured to adjust a propagation direction of the first light beam such that the first meta-optical structures emits the first light beam not-perpendicular to the first meta-optical structure;
a second micro-display configured to emit a second light beam of a color different from a color of the first light beam displayed by the first micro-display;
a light combining element comprising a light exit surface and positioned on optical paths of the first light beam and the second light beam, and configured to receive the first light beam and the second light beam and transmit the first light beam and the second light beam through the light exit surface;
a projection lens configured to receive the first light beam and the second light beam from the light exit surface and project the first light beam and the second light beam at respective angles; and
an optical waveguide configured to receive the first light beam and the second light beam from the projection lens, wherein the projection lens project the first light beam and the second light beam on the optical waveguide in respective directions.
